(19) United States
(12) Patent Application Publication
(10) Pub. No.: US 2008/0086247 A1
(43) Pub. Date: Apr. 10, 2008

(54) Battery management system for vehicles

(75) Inventors: Jae-Sung Gu, Gyeonggi-do (KR); Chin-Gon Kim, Gyeonggi-do (KR); Suk-Hyung Kim, Gyeonggi-do (KR); Sun-Soon Park, Gyeonggi-do (KR)

Correspondence Address: EDWARDS ANGELL PALMER & DODGE LLP, P.O. BOX 55874, BOSTON, MA, 02205, US

(73) Assignee: Hyundai Motor Company, Seoul (KR)

(21) Appl. No.: 11/634,785

(22) Filed: Dec. 5, 2006

(30) Foreign Application Priority Data
Oct. 10, 2006 (KR) 10-2006-0098310

(51) Int. Cl. G06F 7/00

(52) U.S. Cl. 701/36; 307/10.7

(57) ABSTRACT

Disclosed herein is a battery management system for vehicles, comprising: a plurality of slave control units, each of which manages a state of charge of a corresponding battery cell; and a master control unit interfacing with the slave control units to manage a state of charge of all the battery cells.

### CROSS-REFERENCE TO RELATED APPLICATIONS

The present application is based on, and claims priority from, Korean Patent Application Serial Number 10-2006-0098310 filed with Korean Intellectual Property Office on Oct. 10, 2006, the disclosure of which is hereby incorporated by reference herein in its entirety.

### FIELD OF THE INVENTION

The present invention relates to a battery management system for vehicles and, more particularly, to a battery management system suitable for a hybrid electric vehicle or a fuel cell electric vehicle.

### BACKGROUND OF THE INVENTION

FIG. 1 is a block diagram illustrating the construction of a typical hybrid electric vehicle. As shown in the drawing, typical hybrid electric vehicles include a motor 1, an inverter 2, a battery management system (BMS) 3, a battery 4, a generator 5, an engine 6 and a hybrid control unit (HCU) 7.

The engine 6 generates operating force for generating voltage through the combustion of gasoline fuel. The generator 5 is coupled to an output shaft of the engine 6 and generates a predetermined voltage using the operating force transmitted from the engine 6. The battery 4 charges voltage generated in the generator 5 and supplies power to the motor 1 to generate torque.

Furthermore, the battery management system 3 manages the state of charge (SOC) of the battery by determining whether the current, voltage and temperature are within a battery operating range. The inverter 2 serves to change the voltage of the battery into three-phase voltage in order to operate the motor.

The HCU 7 controls overall conditions of a vehicle and the traveling mode thereof, and guides the stable operation of the vehicle with reference to information about the SOC and available power of the battery, which are transmitted from the battery management system 3.

Meanwhile, as shown in FIG. 2, the battery management system 3 includes a current sensing unit, a voltage sensing unit, a temperature sensing and a battery control unit. The current sensing unit and the voltage sensing unit respectively detect the current value and voltage value of the battery 4, and transmit them to the battery control unit. The temperature sensing unit detects the temperature of the battery and transmits it to the battery control unit. The battery control unit receives the detected current, voltage and temperature of the battery 4 and conducts the battery management operation for appropriately maintaining the SOC of the battery 4 with reference thereto.

Meanwhile, the battery management system for the hybrid electric vehicle or the fuel cell electric vehicle uses a number of battery cells equal to K, which are connected to each other in series so as to increase electric energy and power.

However, since such conventional battery management systems use a single battery control unit to manage K battery cells which are connected to each other in series, it is impossible to individually and precisely control the battery cells. Also, for example, when a lithium battery is used in place of a Ni-MH battery, some lithium battery cells may explode as a result of overcharge.

There is thus a need for an improved battery management system that can overcome the problems associated with the conventional systems and more efficiently and stably perform battery management compared with conventional systems.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

In one aspect, the present invention provides a battery management system for a vehicle, comprising a plurality of slave control units, each of which manages a state of charge of a corresponding battery cell, and a master control unit interfacing with the slave control units to manage a state of charge of all the battery cells.

In a preferred embodiment of the present invention, each of the slave control units may preferably comprise a voltage sensing unit to detect a charge voltage value of a corresponding battery cell among a plurality of battery cells. Suitably, the master control unit may comprise a current sensing unit to detect a representative current value of all the battery cells.

Preferably, each of the slave control units may further comprise: a power controller to turn on/off power under control of the master controller; a balancing maintenance unit to operate an equalization circuit of the corresponding battery cell; a temperature sensing unit to detect a temperature of the corresponding battery cell; a slave controller to manage the state of charge of the corresponding battery cell; and an interfacing unit to interface with the master control unit.

Also preferably, the master control unit may further comprises a master controller to control ON/OFF operations of the slave control units and to manage the state of charge of all the battery cells, and an interfacing unit to interface with the slave control units. More particularly, the master controller controls the ON/OFF operations of the slave control units depending on information about traveling conditions of the vehicle that is transmitted from the hybrid control unit.

The master controller transmits the representative current value of all the battery cells, which is detected by the current sensing unit, to the slave controllers. Each of the slave controllers conducts a safety test by comparing the voltage value, detected by the voltage sensing unit, with the representative current value.

The slave controller calculates and transmits the state of charge and a power value of the corresponding battery cell to the master controller. The master controller calculates the state of charge and a power value of all the battery cells with reference to the states of charge and the power values of the battery cells transmitted from the slave controllers and transmits the state of charge and the power value of all the battery cells to a hybrid control unit.

The master control unit may use a subsidiary power supply independent from the slave control units. Also, the slave control units may use a high voltage power supply that is separate from the subsidiary power supply. Furthermore, the slave control units may preferably use communication paths insulated from the master control unit.

Each of the battery cells may suitably comprise a lithium battery cell to be used in a hybrid electric vehicle or a fuel cell electric vehicle.

In another aspect, motor vehicles are provided that comprise a described battery management system.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like. The present battery management system will be particularly useful with a wide variety of motor vehicles.

Other aspects of the invention are discussed infra.

### BRIEF DESCRIPTION OF THE DRAWINGS

For a better understanding of the nature and objects of the present invention, reference should be made to the following detailed description with the accompanying drawings, in which:

FIG. 1 is a block diagram illustrating the construction of a typical hybrid electric vehicle;

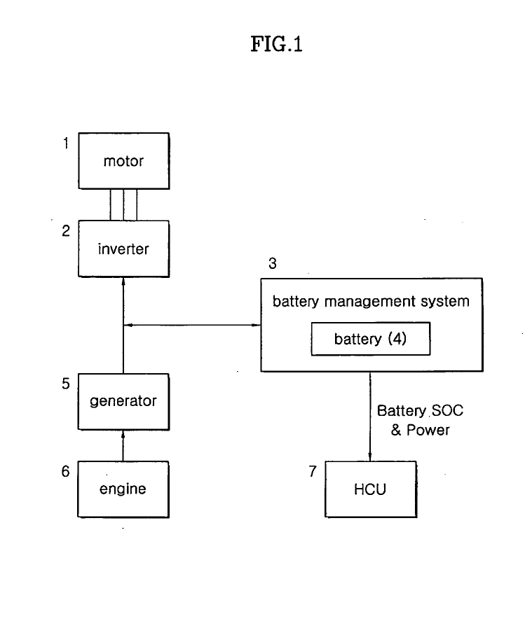

FIG. 2 is a block diagram illustrating the construction of a typical battery management system for vehicles;

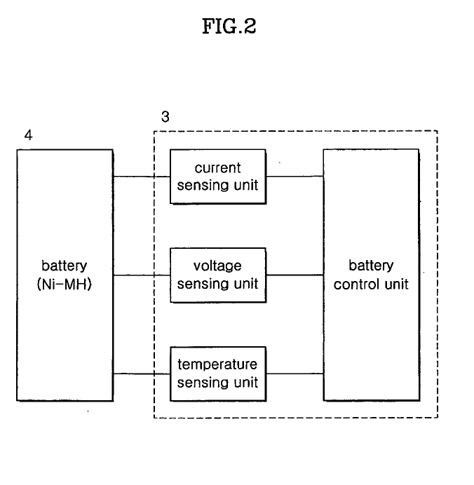

FIG. 3 is a block diagram illustrating the construction of a battery management system for vehicles, according to an embodiment of the present invention; and

FIG. 4 is a flow chart illustrating a battery management process in a master control unit of the battery management system according to the embodiment of the present invention.

### DETAILED DESCRIPTION

Reference will now be made in detail to the preferred embodiment of the present invention, examples of which are illustrated in the drawings attached hereinafter, wherein like reference numerals refer to like elements throughout. The embodiments are described below so as to explain the present invention by referring to the figures.

As discussed above, in one aspect, the present invention provides A battery management system for a vehicle, comprising a plurality of slave control units, each of which manages a state of charge of a corresponding battery cell, and a master control unit interfacing with the slave control units to manage a state of charge of all the battery cells.

In case where a number of battery cells equal to K are connected in series so as to increase electric energy and power performance, it is preferable that the batter y management system includes a master control unit and a plurality of slave control units in order to conduct battery management operation more efficiently.

More particularly, the master control unit manages all of the batteries, and each of the slave control units manages a corresponding battery among the batteries. This battery management system can achieve reliable and efficient management of both all of the battery cells and subgroups batteries.

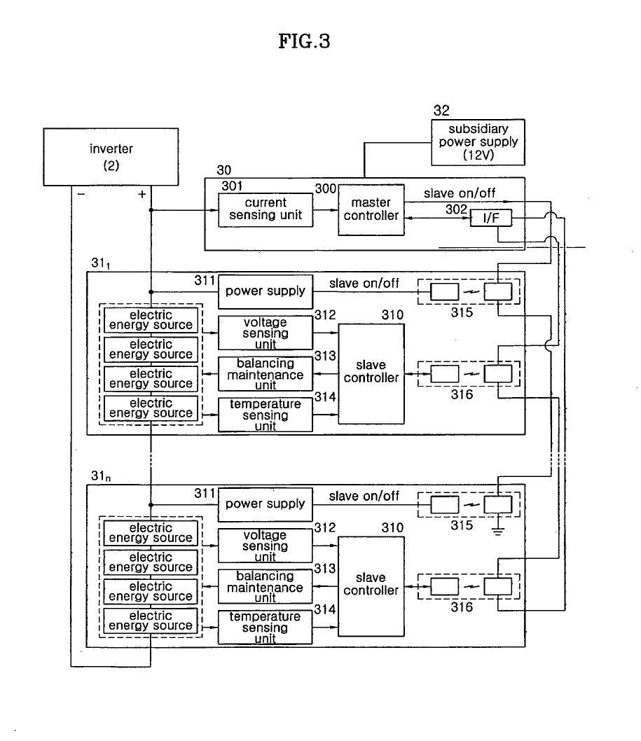

FIG. 3 illustrates the construction of the battery management system for vehicles according to the present invention. In case where, for example, a number of lithium battery cells equal to N are connected in series and used to provide electric energy in place of a single Ni-MH battery, the battery management system includes N slave control units 311 through 31n, which partially and closely manage the state of charge (SOC) of N (for example: four) battery cells, and a single master control unit 30, which interfaces with the slave control units to manage the SOC of all of the battery cells.

In detail, the master control unit 30 includes a current sensing unit 301, which detects the representative current value of all battery cells, a master controller 300, which controls ON/OFF operations of the slave control units and manages the SOC of all battery cells, and an interface unit 302, which is provided to interface with the slave control units.

Furthermore, each slave control unit 31 may comprise a power controller 311, which turns on/off power depending on a slave ON/OFF control signal transmitted from the master controller 300, and a voltage sensing unit 312, which detects the voltage value of a corresponding one among the predetermined number of electric energy sources, for example, four battery cells. The slave control unit 31 may further comprise a balancing maintenance unit 313, which operates an equalization circuit of the corresponding battery cell, a temperature sensing unit 314, which detects the temperature of the corresponding battery cell, a slave controller 310, which manages the SOC of the corresponding battery cell, and an interface unit, which is provided to interface with the master control unit 30.

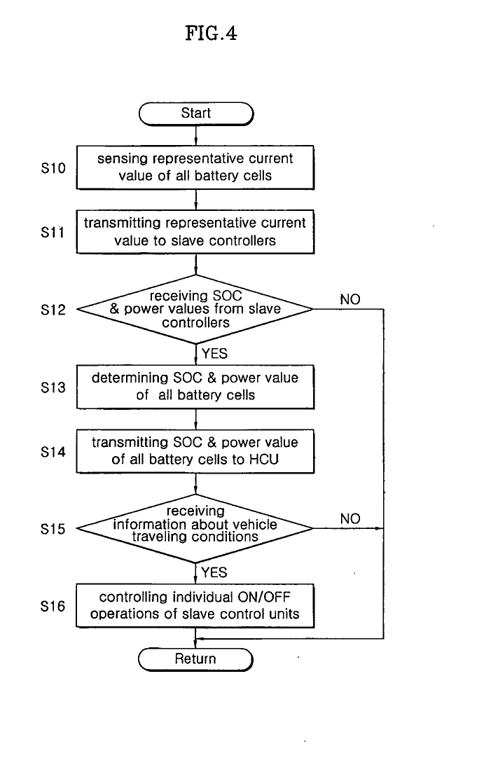

As shown in FIG. 4, in the master controller 300, when the representative current value of all battery cells is detected by the current sensing unit 301 (S10), the representative current value is transmitted to the slave controllers 310 through the interface units 302 (S11).

When the representative current value is transmitted to each slave controller 310 from the master controller 300, the slave controller 310 conducts a safety test that determines whether the ratio of voltage to present current is suitable for conducting a normal charging or discharging operation by comparing the voltage value detected by the voltage sensing unit 312 with the representative current value.

Furthermore, each slave controller 310 calculates the SOC and a power value of the corresponding battery cell with reference both to the voltage value detected by the voltage sensing unit 312 and to the temperature detected by the temperature sensing unit 314, and transmits the results to the master controller 300 through the interface unit 316.

The master controller 300 receives the SOCs and the power values from the slave controllers 310 (S12) and determines the SOC and the power value of all battery cells with reference to the SOCs and the power values of the slave controllers 310 (S13).

After the SOC and the power value of all battery cells are determined, the master controller 300 transmits the SOC and power value of all battery cells to a hybrid control unit (HCU) (S14), such that the determination of a traveling mode and overall vehicle conditions can be normally controlled by the HCU.

Furthermore, the HCU transmits information about vehicle traveling conditions to the master controller 300 such that battery charging or discharging operation is correctly conducted. For example, in case where the master controller 300 receives information about vehicle traveling conditions corresponding to a parking operation (S15), the master controller 300 outputs individual ON/OFF control signals for the slave control units 31 (S16), thus preventing high voltage battery power from being discharged.

Therefore, the master controller 300 can reliably conduct the intended function of the battery management system that provides the SOC and power value of all battery cells to the HCU. Furthermore, the master controller 300 appropriately controls ON/OFF operations of the slave control units in consideration of information about the traveling conditions of the vehicle.

In addition, as shown in FIG. 3, the master control unit may preferably use a subsidiary power supply unit 32, for example, a subsidiary power supply of 12V, which is independent from the slave control units. The slave control units may suitably use separate high voltage power from the subsidiary power supply, so that the wiring and design of a power line can be simplified.

In addition, the slave control units may preferably use communication paths that are insulated from the master control unit, so that insulation between a high voltage system and a low voltage system of 12V can be ensured. Thus, a circuit design can be implemented more stably and easily.

As is apparent from the foregoing, the present invention provides a battery management system for hybrid electric vehicles or fuel cell electric vehicles, which can efficiently and stably conduct battery management. Also, since the battery management system has a simple structure, it can reduce the-manufacturing costs and simplify the design.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A battery management system for a vehicle, comprising:
a plurality of slave control units, each of which manages a state of charge of a corresponding battery cell; and
a master control unit interfacing with the slave control units to manage a state of charge of all the battery cells.

2. The battery management system as defined in claim 1, wherein each of the slave control units comprises a voltage sensing unit to detect a charge voltage value of a corresponding battery cell among a plurality of battery cells and the master control unit comprises a current sensing unit to detect a representative current value of all the battery cells.

3. The battery management system as defined in claim 2, wherein the master control unit further comprises:
a master controller to control ON/OFF operations of the slave control units and to manage the state of charge of all the battery cells; and
an interfacing unit to interface with the slave control units.

4. The battery management system as defined in claim 3, wherein each of the slave control units further comprises:
a power controller to turn on/off power under control of the master controller;
a balancing maintenance unit to operate an equalization circuit of the corresponding battery cell;
a temperature sensing unit to detect a temperature of the corresponding battery cell;
a slave controller to manage the state of charge of the corresponding battery cell; and
an interfacing unit to interface with the master control unit.

5. The battery management system as defined in claim 4, wherein the master controller transmits the representative current value of all the battery cells, which is detected by the current sensing unit, to the slave controllers, and each of the slave controllers conducts a safety test by comparing the voltage value, detected by the voltage sensing unit, with the representative current value.

6. The battery management system as defined in claim 4, wherein the slave controller calculates and transmits the state of charge and a power value of the corresponding battery cell to the master controller.

7. The battery management system as defined in claim 5, wherein the master controller calculates the state of charge and a power value of all the battery cells with reference to the states of charge and the power values of the battery cells transmitted from the slave controllers and transmits the state of charge and the power value of all the battery cells to a hybrid control unit.

8. The battery management system as defined in claim 7, wherein the master controller controls the ON/OFF operations of the slave control units depending on information about traveling conditions of the vehicle that is transmitted from the hybrid control unit.

9. The battery management system as defined in claim 1, wherein the master control unit uses a subsidiary power supply independent from the slave control units.

10. The battery management system as defined in claim 9, wherein the slave control units use a high voltage power supply that is separate from the subsidiary power supply.

11. The battery management system as defined in claim 9, wherein the slave control units use communication paths insulated from the master control unit.

12. The battery management system as defined in claim 1, wherein each of the battery cells comprises a lithium battery cell to be used in a hybrid electric vehicle or a fuel cell electric vehicle.
